(19) United States
(12) Patent Application Publication
(10) Pub. No.: US 2010/0055998 A1
(43) Pub. Date: Mar. 4, 2010

(54) TERMINAL FITTING AND A WIRE CONNECTED WITH A TERMINAL FITTING

(75) Inventor: Tetsuya Aihara, Yokkaichi-City (JP)

Correspondence Address: CASELLA & HESPOS, 274 MADISON AVENUE, NEW YORK, NY, 10016, US

(73) Assignee: SUMITOMO WIRING SYSTEMS, LTD., Yokkaichi-City (JP)

(21) Appl. No.: 12/548,509

(22) Filed: Aug. 27, 2009

(30) Foreign Application Priority Data
Aug. 28, 2008 (JP) 2008-219672

(51) Int. Cl. H01R 4/10

(52) U.S. Cl. 439/877; 439/879

(57) ABSTRACT

A female terminal fitting (12) has wire barrels (17) to be crimped around a core (10) that extends in a first direction. A connecting portion (18) extends from the wire barrels (17) and is connectable with a male terminal fitting. The wire barrels (17) have a contact surface (22) to be held in contact with the core (10). Grooves (30) are formed in a surface of the wire barrels (17) opposite to the contact surface (22) and extend in a second direction intersecting the first direction.

### BACKGROUND OF THE INVENTION

1. Field of the Invention

The invention relates to a terminal fitting and a wire connected with a terminal fitting.

2. Description of the Related Art

Japanese Unexamined Patent Publication No. H10-125362 discloses a terminal fitting with a crimping portion that is configured to be crimped into connection with a core exposed an end portion of a wire. A connecting portion extends from the crimping portion and is configured to be connected with a mating terminal fitting.

An oxide film on the outer surface of the core increases electrical resistance between the wire and the terminal fitting. Accordingly, the prior art terminal fitting includes a recess in a surface of the crimping portion to be held in contact with the core.

The core is deformed plastically upon receiving pressure from the crimping portion during a crimping operation, and hence the core enters the recess. The opening edge of the recess and the outer surface of the core then slide in contact with each other to scrape off the oxide film formed on the outer surface of the core and to expose a newly-formed surface of the core. The contact of this newly-formed surface and the crimping portion reduces electrical resistance between the wire and the terminal fitting.

The crimping operation of the above-described prior art terminal fitting may cause an undesirable change in a dimension of the terminal fitting due to the plastic deformation of the crimping portion. More particularly, the core receives a pressure from the crimping portion, and the crimping portion receives a pressure from the core by reaction. Thus, the crimping portion also is deformed plastically. Hence, there is a concern of significantly changing the length of the terminal fitting in an extending direction of the wire. Specifically, the core and the crimping portion are placed between two molds and the crimping portion then is squeezed from upper and lower sides. The molds are formed with escaping holes in the extending direction of the wire to permit the wire to escape. The pressure from the core causes the crimping portion to deform and project out from the escaping holes, thereby relieving the pressure. Thus, the crimping portion is deformed in the extending direction of the wire, thereby causing the length of the terminal fitting to change significantly in the extending direction of the wire.

A change in the length of the terminal fitting could cause the terminal fitting to project out from a connector housing that is intended to accommodate the terminal fitting.

The invention was developed in view of the above situation and an object thereof is to provide a terminal fitting and a wire connected with a terminal fitting in which a length increase in an extending direction of a wire before and after crimping is suppressed.

### SUMMARY OF THE INVENTION

The invention relates to a terminal fitting with a crimping portion to be crimped, bent, folded or deformed to wind at least partly around a wire that extends in a first direction. A connecting portion extends directly or indirectly from the crimping portion to be connected with a mating terminal fitting. The crimping portion has a contact surface to be held in contact with the wire. At least one groove is formed in a surface of the crimping portion opposite the contact surface and extends in a second direction that intersects the first direction.

The invention also is directed to a wire connected with the above-described terminal fitting. The wire includes a core and the terminal fitting is crimped, bent, folded or deformed into connection with the core exposed at or near an end portion of the wire. The contact surface of the crimping portion of the terminal fitting is held in contact with the core. The wire receives a pressure from the crimping portion when the crimping portion is crimped into connection with the wire and the wire reacts by exerting pressure on the crimping portion. As a result, the crimping portion is deformed plastically so that the groove extending in the second direction becomes narrower in the first direction. Hence, the deformation of the crimping portion in the first direction is absorbed by the groove to suppress a length increase of the terminal fitting in the first direction before and after the crimping operation.

A plurality of grooves may be formed in the crimping portion and may be spaced apart in the first direction. Thus, a deformation amount of the crimping portion absorbed by the grooves increases as compared with the case where there is only one groove. As a result, the length increase of the terminal fitting in the first direction before and after crimping is suppressed further. The contact surface may have at least one recess extending in the second direction. The at least one recess may be offset with respect to the at least one groove along the second direction.

The crimping portion may be crimped, bent, folded or deformed so that end edges of the crimping portion engage a core of the wire from an outer side and/or are held in contact with each other at a position near a center of the terminal fitting in a width direction.

The core may be made of aluminum or aluminum alloy, and hence an oxide film is formed relatively easily formed on the outer surface of the core. The oxide film can be scraped off the core if the crimping portion is crimped into connection with the core by a relative large pressure. However, the crimping portion then is more likely to be deformed plastically. This invention is effective in the case where the crimping portion is crimped into connection with the core by a relatively strong pressure as described above, and suppresses a length increase in the extending direction of the wire before and after crimping.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is a side view showing a wire connected with a terminal fitting according to the invention.

FIG. 2 is a perspective view showing a female terminal fitting.

FIG. 3 is an enlarged plan view showing an essential part of the female terminal fitting before being crimped into connection with a core.

FIG. 4 is a section along IV-IV of FIG. 3.

FIG. 5 is a section along V-V of FIG. 1.

FIG. 6 is an enlarged plan view showing an essential part in a state where wire barrels are crimped into connection with the core.

### DETAILED DESCRIPTION OF THE PREFERRED EMBODIMENTS

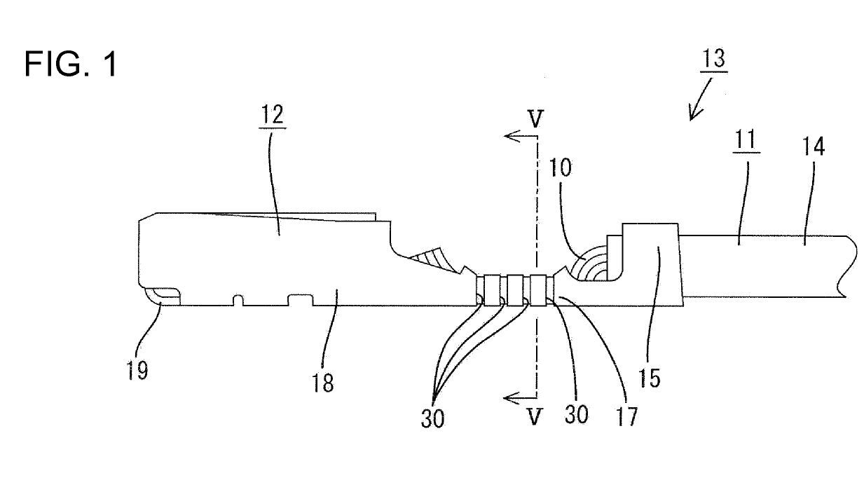

A female terminal fitting in accordance with the invention is identified generally by the numeral 12 in FIGS. 1 to 6. The terminal fitting 12 is crimped, bent or folded into connection with a core 10 exposed at an end of a wire 11. The female terminal fitting 12 is used by being at least partly accommodated in a cavity of an unillustrated connector housing.

As shown in FIG. 1, the core 10 of the wire 11 is formed by twisting a plurality of thin metal wires and an insulation coating 14 made e.g. of synthetic resin surrounds the outer circumferential surface of the core 10. The core 10 preferably is formed from aluminum or aluminum alloy, but may be formed another metal, such as copper or copper alloy.

The female terminal fitting 12 is formed preferably by press-working a conductive metal plate into a specified shape. The metal of the female terminal fitting 12 is selected in accordance with the needs of the system. However, the metal of the female terminal fitting preferably is different from the metal of the core 10. The preferred metal for the female terminal fitting 12 is copper or copper alloy that may be plated with a different metal, such as tin or nickel. Tin plating is preferred in this embodiment. As shown in FIG. 1, the female terminal fitting 12 includes two insulation barrels 15 to be crimped, bent or folded to wind at least partly around the insulation coating 14 of the wire 11. Two wire barrels 17 are connected to the insulation barrels 15 and a connecting portion 18 extends from the wire barrels 17 to be connected with an unillustrated male terminal fitting.

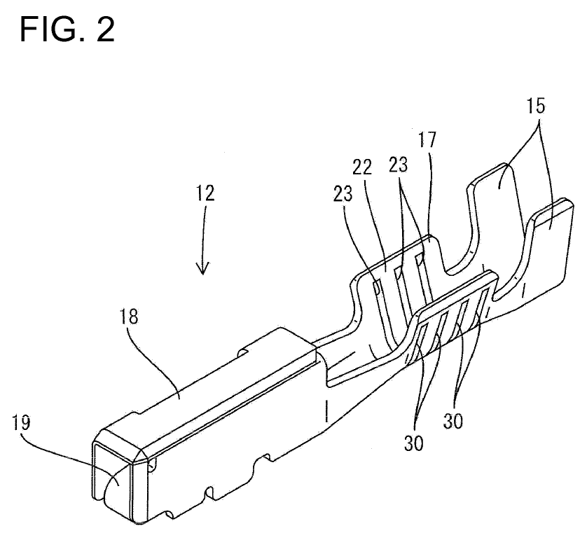

As shown in FIG. 2, the connecting portion 18 is a substantially rectangular tube and the male terminal fitting can be inserted therein. A resilient contact piece 19 is formed in the connecting portion 18, and the male terminal fitting and the female terminal fitting 12 are connected electrically by the resilient contact of the resilient contact piece 19 with the male terminal fitting.

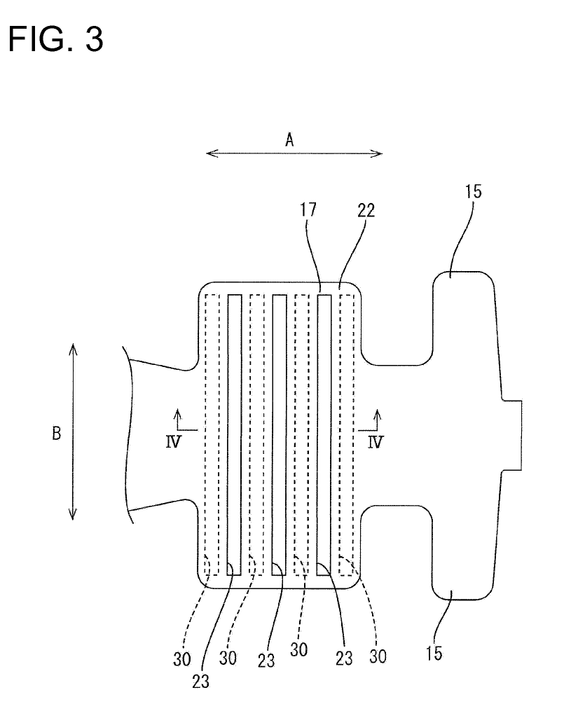

As shown in FIG. 3, the wire barrels 17 have a substantially rectangular shape and are substantially planar or are bent slightly bent toward a U-shape before the core 10 is crimp-connected. The wire 11 extends in a first direction identified by the arrows A in FIG. 3 when the core 10 is crimp-connected with the wire barrels 17. A second direction intersects the first direction A before the core 10 is crimp-connected with the wire barrels 17 and is identified by the arrows B in FIG. 3.

The wire barrels 17 are formed with a contact surface 22 to be held in contact with the core 10. Recesses 23 are formed in the contact surface 22 of the wire barrels 17 and extend in the second direction B. The recesses 23 intersect the first direction A and are spaced apart in the first direction A. In this embodiment, the second direction B is substantially orthogonal to the first direction A. The recesses 23 preferably are formed by press-working or stamping the wire barrels 17 from the side of the contact surface 22.

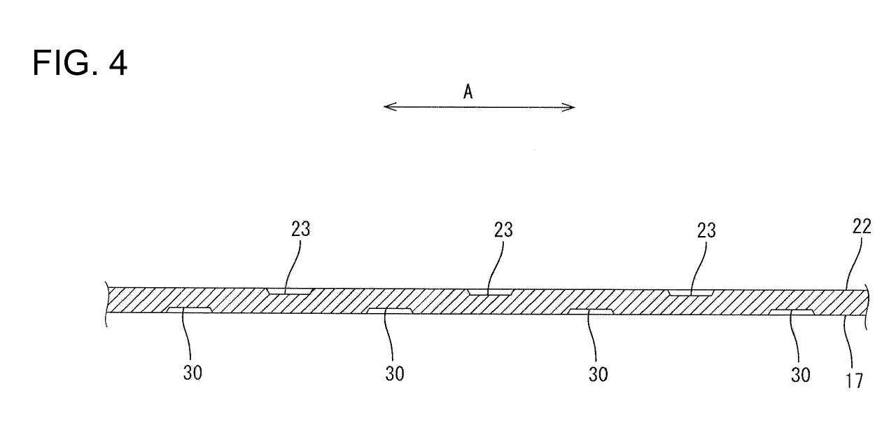

As shown in FIG. 3, grooves 20 are formed in a surface of the wire barrels 17 opposite to the contact surface 22. The grooves 20 extend substantially in the second direction B and intersect the first direction A while being spaced apart in the first direction A. The recesses 23 and the grooves 30 are formed at positions in the wire barrels 17 that are spaced from one another in the first direction A, as shown in FIG. 4.

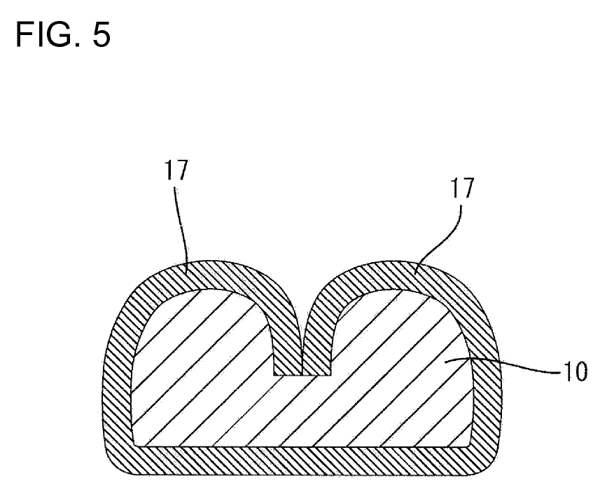

The wire barrels 17 are crimped, bent or folded to wind at least partly around the core 10, as shown in FIG. 5. End edges of the wire barrels 17 engage the core 10 from an outer side (upper side in FIG. 5) and contact each other at a position near a center of the female terminal fitting 12 in a width direction (lateral direction in FIG. 5). For simplicity, the detailed structure of the core 10 is not shown in FIG. 4.

The crimping, bending or folding of the wire barrels 17 to wind at least partly around the core 10, causes the wire barrels 17 to exert pressures on the core 10. Thus, an oxide film formed on the outer surface of the core 10 is broken to expose a newly formed surface of the core 10, and the wire 11 and the female terminal fitting 12 are connected electrically by the contact of this newly-formed surface and the contact surface 22 of the wire barrels 17.

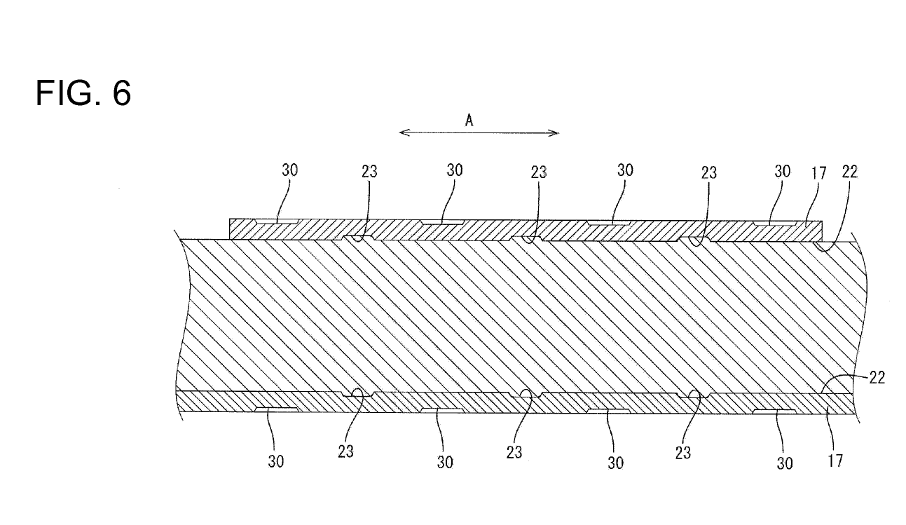

Pressure from the wire barrels 17 plastically deforms the core 10 as the wire barrels 17 are crimped, bent or folded into connection with the core 10, and the plastically deformed core 10 enters the recesses 23 in the contact surface 22 of the wire barrels 17, as shown in FIG. 6. Opening edges of the recesses 23 slide in contact with the outer surface of the core 10 and scrape off or break the oxide film of the core 10 to expose a newly-formed surface of the core 10. The contact of this newly-formed surface of the core 10 and the contact surface 22 of the wire barrels 17 achieves a more reliable electrical connection between the wire 11 and the female terminal fitting 12.

The newly-formed surface of the core 10 made of aluminum or aluminum alloy and the tin plating layer formed on the outer surface of the female terminal fitting 12 slide in contact upon receiving the pressures to form an alloy layer. In this way, electrical resistance between the wire 11 and the female terminal fitting 12 is reduced further.

The conductive metal plate material for the female terminal fitting 12 is stamped or press-formed into the specified shape. The recesses 23 and the grooves 30 may be formed at this time.

The metal plate material is bent to form the connecting portion 18, and the recesses 23 and the grooves 30 may be formed, if not formed previously. In this way, the female terminal fitting 12 is completed.

The insulation coating 14 at the end portion of the wire 11 is removed to expose the core 10. The female terminal fitting 12 is placed on an unillustrated lower mold and the exposed core 10 is placed on the wire barrels 17 of the female terminal fitting 12. An unillustrated upper mold then is moved toward the lower mold and crimps, bends or folds the insulation barrels 15 to wind at least partly wind around the insulation coating 14 of the wire 11. The upper mold also crimps, bends or folds the wire barrels 17 to wind around the core 10. In this way, the wire 13 connected with the terminal fitting is completed.

The crimping, bending or folding of the wire barrels 17 at least partly around the core 10 causes the wire barrels 17 to give pressure to the core 10. As a result, the oxide film formed on the outer surface of the core 10 is broken to expose a newly-formed surface of the core 10. The wire 11 and the female terminal fitting 12 are connected electrically by the contact between this newly-formed surface and the contact surface 22 of the wire barrels 17.

The crimped, bent or folded wire barrels 17 exert pressure on the core 10 and plastically deform the core 10 sufficiently to enter the recesses 23. The oxide film on the outer surface of the core 10 is scraped off by the sliding contact of the opening edges of the recesses 23 with the outer surface of the core 10 to expose a newly-formed surface of the core 10. The electrical resistance between the wire 11 and the female terminal fitting 12 is reduced further by the contact of this newly-formed surface and the wire barrels 17.

The core 10 receives pressure from the crimped, bent or folded wire barrels 17, and, in reaction, the core 10 exerts pressure on the wire barrels 17. As a result, the wire barrels 17 are deformed plastically so that the grooves 30 extending in the second direction B in FIG. 3 become narrower in the first direction A (see FIG. 6).

In this way, grooves 30 absorb the deformations of the wire barrels 17 in the first direction A in FIG. 6. As a result, the wire barrels 17 will not lengthen in the first direction A as a result of the crimping operation. Consequently, the female terminal fitting 12 will not project out from the connector housing even after the wire barrels 17 are crimped, bent, folded or deformed into connection with the core 10.

Plural grooves 30 preferably are formed to absorb a larger amount of deformation of the wire barrels 17 as compared, for example, to the case where only one groove 30 is formed. As a result, a length increase of the female terminal fitting 12 in the first direction A is suppressed even more.

The core 10 preferably is made of aluminum or aluminum alloy, and hence an oxide film is likely to be formed on the outer surface of the core 10. The oxide film could be scraped off the core 10 if the wire barrels 17 are crimped, bent or folded into connection with the core 10 by relative large pressures. However, the wire barrels 17 are more likely to be deformed plastically these large pressures. The above-described invention is effective in the case where the wire barrels 17 are crimped into connection with the core 10 by relatively strong pressures.

The invention is not limited to the above described and illustrated embodiment. For example, the following embodiments are also included in the technical scope of the present invention.

The wire barrels 17 have four grooves 30 in the illustrated embodiment, but one, two, three, five or more grooves 30 may be formed.

The grooves 30 are offset from the recesses 23 in the first direction A in the illustrated embodiment. However, the grooves 30 may align with the recesses 23 or may be at arbitrary positions with respect to the recesses 23.

The second direction is orthogonal to the first direction in the illustrated embodiment. However, the second direction may be any direction that intersects the first direction.

The wire barrels 17 may be crimped into connection with the core 10 with the ends thereof displaced in the extending direction of the wire 11, or ends of three or more wire barrels 17 may be formed alternately at opposite left and right sides, or only one wire barrel 17 may be crimped into connection with the core 10, or the wire barrel 17 may have an arbitrary shape according to needs.

Although the wire barrels 17 are formed with the recesses 23 in the above embodiment, the recesses 23 may be omitted.

The terminal fitting may be a male terminal fitting.

What is claimed is:

1. A terminal fitting (12), comprising:
a connecting portion (18) configured to be connected with a mating terminal fitting; and
a crimping portion (17) extending from the connecting portion (18) and configured to be crimped to wind at least partly around a wire (11) that extends in a first direction (A), the crimping portion (17) including a contact surface (22) to be held in contact with the wire (11), and at least one groove (30) formed in a surface of the crimping portion (17) opposite to the contact surface (22) and extending in a second direction (B) that intersects the first direction (A).

2. The terminal fitting of claim 1, wherein the at least one groove (30) comprises a plurality of grooves (30) spaced apart in the first direction (A).

3. The terminal fitting of claim 1, wherein the contact surface (22) is formed with at least one recess (23) extending in the second direction (B).

4. The terminal fitting of claim 3, wherein the at least one recess (23) is offset with respect to the at least one groove (30) along the second direction (B).

5. A terminated conductive assembly, comprising:
a wire (11) including a core (10) extending in a first direction (A); and
a terminal fitting (12) having a connecting portion (18) configured to be connected with a mating terminal fitting and a crimping portion (17) extending from the connecting portion (18), the crimping portion (17) being crimped to wind at least partly around the core (10) of the wire (1 1) and including a contact surface (22) held in contact with the wire (11), at least one groove (30) being formed in a surface of the crimping portion (17) opposite to the contact surface (22) and extending in a second direction (B) that intersects the first direction (A).

6. The assembly of claim 5, wherein a plurality of grooves (30) are formed in the crimping portion (17) while being spaced apart in the first direction (A).

7. The assembly of claim 6, wherein the core (10) is made of aluminum or aluminum alloy.

8. The assembly of claim 5, wherein the crimping portion (17) is crimped so that end edges of the crimping portion (17) are held in contact with or engage the core (10) of the wire (11) from an outer side and are held in contact with each other at a position near a center of the terminal fitting (12) in a width direction.

9. The assembly of claim 5, wherein the contact surface (22) is formed with at least one recess (23) extending in the second direction (B).

10. The assembly of claim 5, wherein the at least one recess (23) is offset with respect to the at least one groove (30) along the second direction (B).
